(19) United States
(12) Patent Application Publication
(10) Pub. No.: US 2020/0320202 A1
(43) Pub. Date: Oct. 8, 2020

(54) PRIVACY VULNERABILITY SCANNING OF SOFTWARE APPLICATIONS

(71) Applicant: International Business Machines Corporation, Armonk, NY (US)

(72) Inventors: ARIEL FARKASH, Shimshit (IL); Abigail Goldsteen, Haifa (IL); RON SHMELKIN, Haifa (IL)

(21) Appl. No.: 16/374,766

(22) Filed: Apr. 4, 2019

(51) Int. Cl. G06F 21/57; G06N 20/00

(52) U.S. Cl. CPC G06F 21/577; G06F 2221/033; G06N 20/00

(57) ABSTRACT

Conducting a privacy vulnerability assessment of a software application that comprises program code, by performing at least one of: (i) evaluating the program code to identify code segments presenting a potential dissemination of specified data to an unauthorized destination, (ii) detecting one or more execution paths in the software application which use the specified data for an unauthorized purpose, and (iii) analyzing the content of data flows from the software application to detect the specified data in the data flows. Then, generating one or more vulnerability summaries, based, at least in part, on the results of the evaluating, the detecting, and the analyzing.

### CROSS-REFERENCE TO RELATED APPLICATIONS

This application claims the benefit of U.S. Provisional Patent Application No. 62/720,993, filed Aug. 22, 2018, entitled “Privacy Vulnerability Scanning of Software Applications”, which incorporated herein by reference in its entirety.

### BACKGROUND

The invention relates to the field of software development.

Worldwide and local privacy regulations mandate the protection of digitally-stored person-specific data against unauthorized use, sharing with third parties or across regions and borders. Failure by enterprises to comply with data privacy regulations may lead to regulatory action and reputational harm.

Like security flaws, software applications can also have privacy vulnerabilities, which can cause data to leak or be incorrectly processed or stored, either inadvertently or through malicious action. Oftentimes, these privacy vulnerabilities are created inadvertently during the development process. Therefore, testing software applications before deployment for potential privacy-related flaws may become an important step in software development for enterprises.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, method comprising operating at least one hardware processor for: receiving a software application comprising program code, conducting a privacy vulnerability assessment of the application by performing at least one of: (i) evaluating said program code to identify code segments presenting a potential dissemination of specified data to an unauthorized destination, (ii) detecting one or more execution paths in the software application which use said specified data for an unauthorized purpose, and (iii) analyzing the content of data flows from said software application to detect said specified data in said data flows, and generating one or more vulnerability summaries, based, at least in part, on the results of said evaluating, said detecting, and said analyzing.

There is also provided, in accordance with an embodiment, a system comprising at least one hardware processor; and a non-transitory computer-readable storage medium having stored thereon program instructions, the program instructions executable by the at least one hardware processor to: receive a software application comprising program code, conduct a privacy vulnerability assessment of the application by performing at least one of: (i) evaluating said program code to identify code segments presenting a potential dissemination of specified data to an unauthorized destination, (ii) detecting one or more execution paths in the software application which use said specified data for an unauthorized purpose, and (iii) analyzing the content of data flows from said software application to detect said specified data in said data flows, and generate one or more vulnerability summaries, based, at least in part, on the results of said evaluating, said detecting, and said analyzing.

There is further provided, in accordance with an embodiment, a computer program product comprising a non-transitory computer-readable storage medium having program instructions embodied therewith, the program instructions executable by at least one hardware processor to: receive a software application comprising program code, conduct a privacy vulnerability assessment of the application by performing at least one of: (i) evaluating said program code to identify code segments presenting a potential dissemination of specified data to an unauthorized destination, (ii) detecting one or more execution paths in the software application which use said specified data for an unauthorized purpose, and (iii) analyzing the content of data flows from said software application to detect said specified data in said data flows, and generate one or more vulnerability summaries, based, at least in part, on the results of said evaluating, said detecting, and said analyzing.

In some embodiments, said specified data comprises private information related to one or more individual persons.

In some embodiments, said evaluating is based, at least in part, on a static analysis, wherein said static analysis is performed without execution of the application.

In some embodiments, said evaluating comprises at least one of: (a) identifying code segments which permit sending said specified data to an Internet Protocol (IP) address located in a specified jurisdiction; and (b) identifying code segments which permit sending said specified data to at least one of a permanent computer-readable storage medium, and a non-transitory computer-readable storage medium.

In some embodiments, at least one of (a) and (b) is performed by analyzing one or more libraries referenced by the program code.

In some embodiments, said evaluating is based, at least in part, on a dynamic analysis comprising: (i) populating said application with simulated said specified data; and (ii) analyzing the content of data flows from said identified code segments, to detect said simulated specified data in said data flows.

In some embodiments, populating is based, at least in part, on fuzzing techniques.

In some embodiments, said detecting of said execution paths comprises: (i) training a machine learning algorithm on a training set comprising: (ii) identified authorized execution paths within said application, and (iii) labels associated with a purpose of each said authorized execution paths, to produce a classifier configured to classify execution paths based, at least in part, on one or more purposes; and applying said classifier to said program code, to determine whether one or more execution paths are not associated with an allowed purpose.

In some embodiments, said authorized execution path is labelled with said associated purpose.

In some embodiments, said authorized execution paths are identified using at least one of: functions traces, control flows, procedure calls, and system calls.

In some embodiments, said purposes are determined based, at least in part, on one or more one of: manual identification, a name associated with a said execution path, and an output associated with a said execution path.

In some embodiments, said analyzing of said content comprises at least one of: natural language processing (NLP), sensitive data discovery, and data classification.

In some embodiments, said analyzing comprises data flows received in response to one or more (i) Application Programming Interface (API) calls; and (ii) data requests delivered to said application.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of the functional elements of the present invention, according to an embodiment;

FIG. 2A illustrates an example of identification of personal information on a web page;

FIG. 2B is a block diagram of an exemplary content analysis module, according to an embodiment;

FIG. 2C is a schematic illustration of a privacy-related classification model, according to an embodiment;

FIG. 3 illustrates function traces/control flows analysis, according to an embodiment; and

FIG. 4 illustrates dynamic content analysis with respect to saving data to permanent or long-term storage device, according to an embodiment.

### DETAILED DESCRIPTION

Disclosed herein are a system, a method, and a computer program product for scanning and detecting potential privacy vulnerabilities in software applications.

In some embodiments, the present invention provides one or more software development tools for automated scanning and detection of potential software application-level privacy-related vulnerabilities and/or flaws during development stages.

In some embodiments, a privacy scanner tool of the present invention may be configured for performing static and/or dynamic analyses of an application's code, for testing and privacy vulnerability assessments during the development stage and prior to deployment of the application. In some embodiments, the privacy scanner may then be configured for providing a list of potential privacy vulnerabilities and/or flaws, which may necessitate fixes before deploying the application in a production environment, thus solving any issues before they may cause an actual privacy breach. In some embodiments, the privacy scanner may be configured for testing an application to determine compliance with one or more specified regulations in the area of privacy.

As noted above, privacy regulations, such as the recent EU General Data Protection Regulation (GPDR), impose large penalties on companies for privacy breaches. In addition, companies may face reputational damage from mishandling customers' private data. As such, the present invention may be especially useful for service providers such as online retailers, financial institutions, healthcare providers, and any other enterprise digitally hosting large amounts of customers' personal information, which must be protected from intentional misuse and/or misappropriation, as well as unintentional leaks. Unintended privacy breaches can result, e.g., when data containing private information is sent to the wrong recipients, used for purposes for which they are not authorized, stored in inappropriate storage mediums or locations, or when servers are left publicly accessible. Intentional misappropriation may result when an unauthorized third party gains access into the service provider's servers and uses, e.g., individuals' addresses, financial transactions, or medical records, for financial fraud, identity theft, harassment, and the like.

In order to maintain compliance with privacy regulation, data controllers and processors all over the world will have to seek to eliminate privacy vulnerabilities specifically during application development and/or updates. Even small changes in an application's code can implicitly change the data usage purpose, and create new vulnerabilities.

As used herein, the term “private information” (PI) is used broadly, to include all types of information relating to an individual's private, professional, or public life. PI can encompass any data point regarding the individual—such as a name, a home address, a photograph, email or phone contact details, bank details, posts on social networking websites, medical information, or a computer's IP address, to name a few. One sub-category of PI includes ‘personally identifiable information’ (PII), which is generally information that can be used on its own or with other information to identify, contact, and/or locate an individual. ‘Sensitive personal information’ (SPI) is defined as information that if lost, compromised, or disclosed could result in substantial harm, embarrassment, inconvenience, or unfairness to an individual.

A potential advantage of the present invention is, therefore, in that it provides for a comprehensive tool for detecting privacy weaknesses offline, in a test environment, without risking an actual privacy breach in runtime.

In some embodiments, the present invention may employ a combination of static and dynamic testing and assessment tools configured for detecting privacy vulnerabilities in an application, which may include, but are not limited to:
Content analysis tools (including deep learning tools), such as Natural Language Processing (NLP), sensitive data discovery, and/or data classification, configured for detecting the existence of PI in structured and/or unstructured data flows.
Machine learning techniques configured for learning associations between application traces/data flows and the declared purpose of the data usage in such flows, to detect deviations from such declared purposes.
Data flow analysis tools configured for scanning application code and identifying points where data, e.g., may be sent out of region or to long-term storage media.
Fuzz testing to generate a variety of data for dynamic testing of application flows.

In some embodiments, potential privacy-related vulnerabilities which may be detected by the privacy scanner include, but are not limited to:
Unauthenticated access to PI, for example, by harvesting or ‘scraping’ data from a Representational State Transfer (REST) Application Programming Interface (API);
using PI for unauthorized purposes;
mismatches between declared purpose and actual usage of PI;
transfers of PI to unauthorized locations, e.g., cross-border; and
storing PI on long-term media or non-erasable devices, e.g., when data subject consent cannot be updated, or data cannot be deleted ('right to be forgotten').

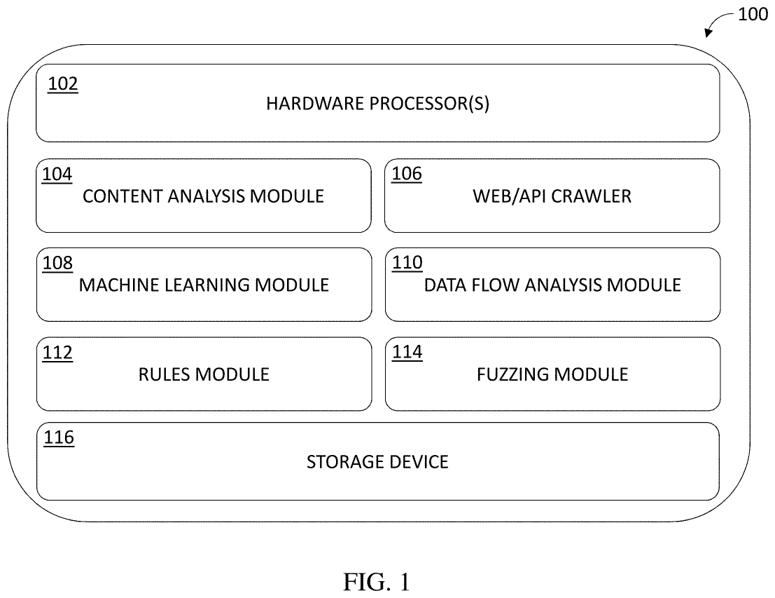

FIG. 1 is a block diagram of an exemplary privacy scanner 100, according to an embodiment. Privacy scanner 100 as described herein is only an exemplary embodiment of the present invention, and in practice may be implemented in hardware, software only, or a combination of both hardware and software. Privacy scanner 100 may have more or fewer components and modules than shown, may combine two or more of the components, or may have a different configuration or arrangement of the components. In various embodiments, privacy scanner 100 may comprise one or more dedicated hardware devices, one or more software tools, and/or may form an addition to or extension of an existing device.

In some embodiments, privacy scanner 100 may comprise one or more hardware processors 102. In addition, privacy scanner 100 may comprise a content analysis module 104, a Web/API crawler 106, a machine learning module 108, a data flow analysis module 110, a rules module, a fuzzing module 114, and a non-transitory computer-readable memory storage device 116. Privacy scanner 100 may store in storage device 116 software instructions or components configured to operate a processing unit (also “hardware processor,” “CPU,” or simply “processor”), such as hardware processor 102. In some embodiments, the software components may include an operating system, including various software components and/or drivers for controlling and managing general system tasks (e.g., memory management, storage device control, power management, etc.), and facilitating communication between various hardware and software components.

An overview of the functional modules of privacy scanner 100 will be now provided.

In some embodiments, rules module 112 may be used for generating rules which reflect relevant regulatory regimes, policies and procedures in the environment in which the application will be deployed. For example, rules module 122 may be used for defining, e.g., types of data which may be considered to be PI, regions to which data transfer may be prohibited, customer PI preferences update requirements, and the like.

In some embodiments, a privacy scanner of the present invention, such as privacy scanner 100 shown in FIG. 1, may be configured for detecting unauthorized access to PI ‘at the edge,’ i.e., with respect to external requests for extracting, downloading, and/or sending data from the application. In some embodiments, privacy scanner 100 may be configured for performing static assessment of, e.g., the application's code and/or RESTful APIs of the application, to determine privacy vulnerabilities. For example, privacy scanner 100 may employ a tool such as Swagger, which is an open source software framework that helps developers design, build, document, and analyze RESTful Web services, to check for unauthenticated access to PI.

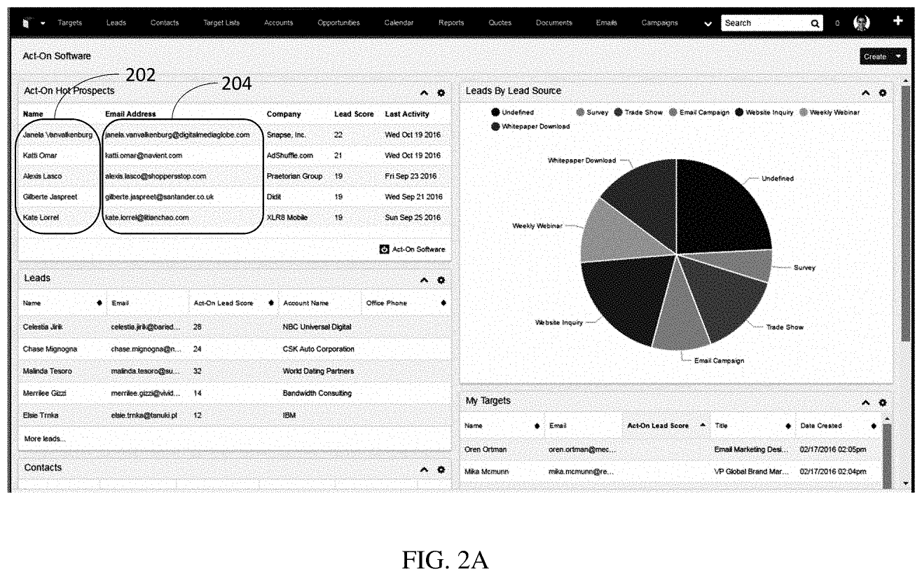

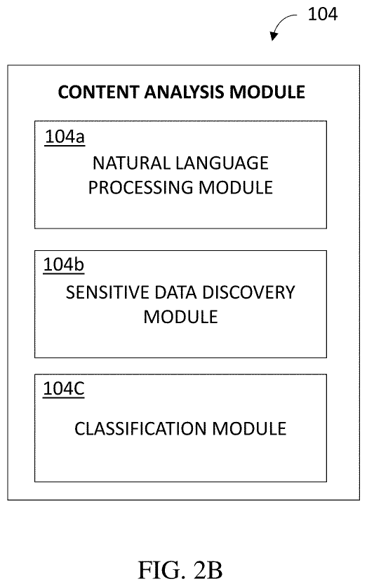

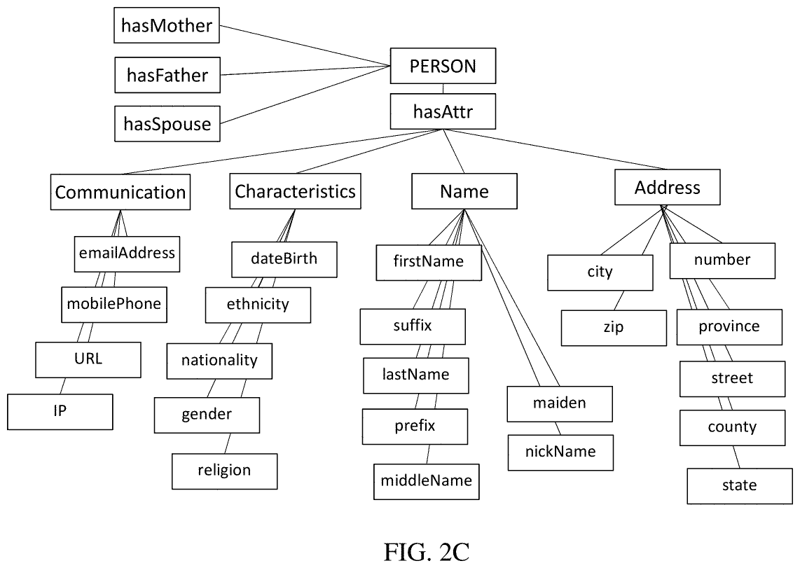

In some embodiments, ‘at the edge’ unauthorized data access may be detected based, at least in part, on content analysis, to detect possible PI in the data flow. Thus, privacy scanner 100 may be configured for performing dynamic assessment using test data to determine whether third-parties can access and extract PI from the application. One type of unauthorized access to PI by third parties is through harvesting or ‘scraping’ data, e.g., from a web page or RESTful API of the application. While web scraping can be done manually by a software user, the term typically refers to automated processes implemented using a bot or web crawler. It is a form of copying, in which specific data is gathered and copied from the web, typically into a central local database or spreadsheet, for later retrieval or analysis. Web scraping a web page involves fetching it for later processing, which may involve parsing, searching, reformatting, and/or copying the page's data into a spreadsheet. Web scraping is used for contact scraping, and as a component of applications used for web indexing, web mining and data mining, online price change monitoring and price comparison, product review scraping (to watch the competition), gathering real estate listings, weather data monitoring, website change detection, research, and tracking online presence and reputation. FIG. 2A illustrates an example of contact scraping from a web page, where names and email addresses of individuals, referenced by sections 202 and 204, respectively are found and copied from the page.

Accordingly, in some embodiments, web/API crawler 106 of privacy scanner 100 may be configured for scraping an application under assessment, for the purpose of extracting data from the application. Another example is using a security tool, such as IBM Security AppScan (www.ibm.com/security/application-security/appscan) to scrape data form the application. The extracted data and content may then be processed by content analysis module 104, to determine whether the data/content contains any information which may contain PI and/or similar sensitive data.

Another example of unauthorized access to PI may be requests to application databases for storing/retrieving data, and/or system calls for saving data to a file and/or sending it over the internet. In some embodiments, content analysis module 104 further be configured for processing such data flows to determine whether they contain any PI and/or similar sensitive data. In some embodiments, such data processing may be based, at least in part, on at least some of Natural Language Processing (NLP), data discovery and classification, and image recognition and classification.

FIG. 2B is a block diagram of an exemplary content analysis module 104. In some embodiments, content analysis module 104 may comprise a Natural Language Processing (NLP) module 104a, configured for analyzing structured and/or unstructured data comprising textual elements, and to draw inferences from the text regarding the existence of PI, PII, and/or other types of sensitive data. In some embodiments, NLP processing module 104a is based on one or more known NLP interface technologies, such as the IBM Watson Conversation service.

In some embodiments, content analysis module 104 may further comprise a sensitive data discovery module 104b and classification module 104c. In some embodiments, discovery module 104b and/or classification module 104c may employ different machine learning techniques and methods, e.g., through machine learning module 108. Such techniques may include Principal Component Analysis (PCA), neural network applications, convolutional neural networks (CNNs), support vector machine (SVM) models, Self-Organizing Maps, Learning Vector Quantization (LVQ) methods, Discrete Wavelet Transform (DWT) parameters, a Bayesian filter, and/or a Kalman filter.

Content analysis module 104 may thus be configured for processing enterprise data in varied formats (unstructured, semi-structured and structured data), to discover PI and classify it according to one or more suitable classification models. A PI-related semantic classification model which may be used in this context is illustrated in FIG. 2C. As can be seen, a root element of the model is Person, and it contains categories such as Person Name, Characteristics, Communications, and Address. Each category in turn contains fields such as ‘First Name,’ Middle Name,' and ‘Last Name.’ Similar models may be developed based, e.g., on rules generated through rules module 114, depending on the regulatory regime within which the application will be ultimately deployed. By applying a similar model to data flow, content analysis module 104 may be able to identify and classify PI in the data flow. The existence of PI in an unauthorized or unauthenticated data flow may then flag a potential privacy vulnerability. For further details regarding similar discovery and classification tools, see, for example, the IBM Security Guardium suite (www.ibm.com/security/data-security/guardium), as well as Ben-David D. et al., Enterprise Data Classification using Semantic Web Technologies, In: Patel-Schneider P. F. et al. (eds) The Semantic Web-ISWC 2010. Lecture Notes in Computer Science, vol 6497.

In some embodiments, privacy scanner 100 may be configured for detecting data misuse during processing/computation by the application. For example, data flow analysis module 110 may be configured for analyzing function traces/control flows of the running application, to discover traces/flows where data may be used for an unauthorized purpose. Each such trace/flow can be associated with a purpose, such that any deviation from the authorized flows may be detected on that basis. In some embodiments, the association between application traces/flows and purposes can be done manually, and/or learned using machine learning techniques, e.g., by employing machine learning module 108.

In some embodiments, data flow analysis module 110 may be configured for associating function traces with a purpose, based, at least in part, on labels used by high-level APIs in the application. For example, if a marketing application has a REST API entitled ‘Send marketing email’ or ‘Send monthly newsletter,’ the association may be based on the title of the API.

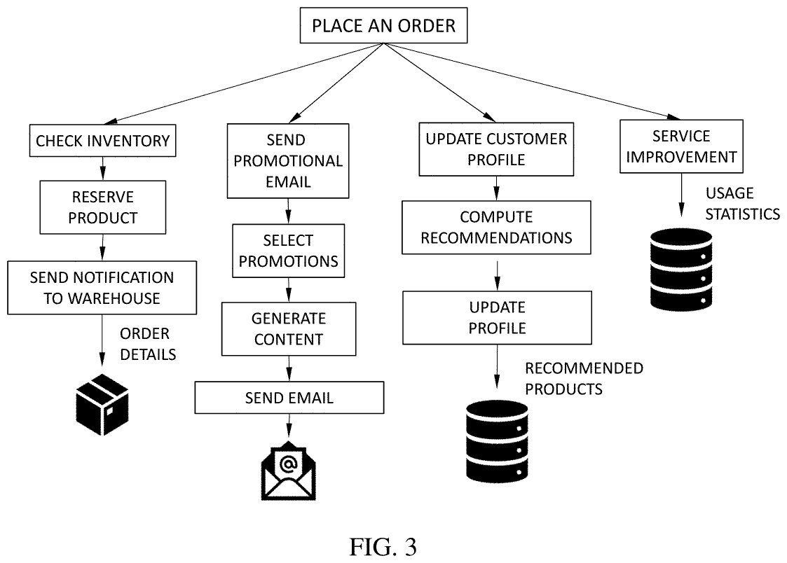

In another example illustrated in FIG. 3, data flow analysis module 110 may analyze the outputs that come out of application APIs, to generate the associations. For example, in the case of placing an order by a customer on a retail website, the following actions may be triggered by multiple APIs within the application:
Placing the actual order: Sends a message to the provisioning/warehouse application to deliver the order to the customer's address.
Sending the customer a promotion email: Sends an email with a certain title and content to the customer.
Updating the customer profile: Writes to the customer's profile in a database, e.g., a list of products to recommend to the customer in a subsequent visit to the website.
Service improvement: Sends usage statistics (such as user clicks, time spent on pages, etc.) to a service improvement data base.

Each of these outputs is associated with a declared specific purpose, as depicted in FIG. 3.

In yet another example, data flow analysis module 110 may be configured for grouping together several APIs/microservices within the application, which are deemed to have a similar purpose. The APIs/microservices may then be compared by their procedure calls/system and/or calls/imported/referenced libraries, wherein a deviation by an API/microservice from a learned expected pattern may flag a potential privacy vulnerability.

Once the associations between tracers/flows and purpose have been generated, data flow analysis module 110 may be configured for generating a model that represents the function traces for each purpose, and may be able to classify new traces/flows accordingly. In some embodiments, a training set for training a classifier of data flow analysis module 110 may comprise test-flows generated using software testing and analysis tools, such as IBM ExpliSAT. In some variations, fuzz testing using, e.g., fuzzing module 114 may be used, to generate a large variety of flows in the application, so as to cover the largest possible percentage of the code.

In some embodiments, privacy scanner 100 may be configured for detecting potential points, processes, and/or data flows where data may be sent outside of an authorized area. For example, some jurisdictions may be subject to data-localization policies, where certain type of data must be stored locally and prohibited from being transferred to other jurisdictions. In some cases, the prohibition may be limited only to countries that do not have an adequate privacy-related regulatory regime in place.

Accordingly, privacy scanner 100 may be configured for assessing, e.g., through static and/or dynamic testing, whether an application will permit the transfer of data to IP addresses from one or more prohibited jurisdictions. A list of prohibited jurisdictions may be entered, e.g., using rules module 114. Static testing may comprise assessing application code for detecting application points which may permit the sending of data to an IP address outside of a permitted region. Privacy scanner 100 may also incorporate dynamic testing to determine cross-border vulnerabilities, based, e.g., on generating test data and applying content analysis module 104 to the output data, to detect potential PI.

Similarly to cross-border analysis, in some embodiments, privacy scanner 100 may be configured for detecting potential points, processes, and/or data flows which may cause PI to be stored on permanent and/or long-term, non-transitory storage media. Long term storage of PI may be deemed to increase a risk of privacy breach, because it may not permit updates to customer consent preferences or complete deletion of data. Some examples of such storage device or locations include Blockchain, CD-ROM/DVD, magnetic tapes, external hard drive, and/or USB devices.

In some embodiments, privacy scanner 100 may be configured for detecting, in the application's program code, calls to a database of the application for storing data, system calls for saving data to a file, and/or references to external libraries, etc. For example, in the case of Blockchain, Node.js applications may use a specified IBM module (github.com/IBM-Blockchain-Archive/ibm-blockchain-js), while other applications may call specified REST APIs, which may be known (such as the HyperLedger Fabric core APIs), can be identified by name (e.g., GET/chain, GET/transactions, etc.), and/or are network-specific APIs with custom names. Privacy scanner 100 may also be configured for searching for keywords in file names or comments to narrow the search, e.g., blockchain, bc, hyperledger, etc., and/or common strings such as ‘resource:’, ‘$class’.

Similarly, burning data to a compact disk (CD) can be detected through dedicated applications, or from code. For example:
Sharprecorder-C# library (code.google.com/archive/p/sharprecorder);
IMAPI2 Windows API (www.codeproject.com/Articles/24544/Burning-and-Erasing-CD-DVD-Blu-ray-Media-with-C-an);
Libburn-C library for Linux (dev.lovelyhq.com/libburnia/web/wikis/home);
Linux command line: cdrecord; and
Calls to external burning tools (e.g., brasero, xfburn, cdw, CreateCD, CDBurnerXP, ImgBurn)

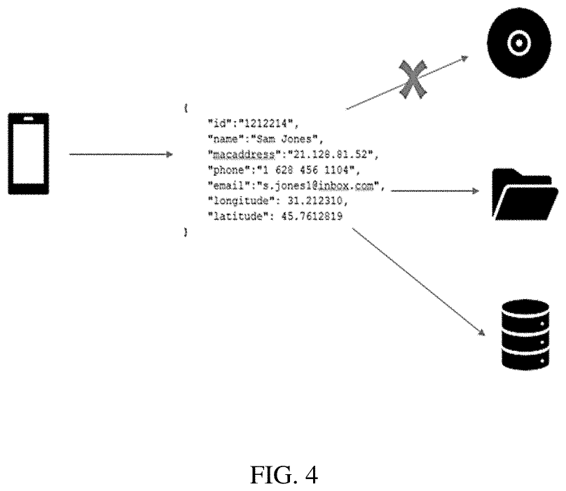

In some embodiments, privacy scanner 100 may be configured for performing dynamic analysis to detect potential PI being sent to permanent/long term storage media. For example, using the places in the code that were detected in the course of the static analysis, privacy scanner 100 may generate test data that resembles runtime data which may be used by the application. As illustrated in FIG. 4, privacy scanner 100 may determine, based on a content analysis of the data flow, that a system call or a path which leads to burning the data to a CD may present a potential privacy vulnerability. In some cases, fuzzing module 114 may generate a variety of data runs. Content analysis module 104 may then be employed to detect PI in the data.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
operating at least one hardware processor for:
receiving a software application comprising program code,
conducting a privacy vulnerability assessment of the software application by performing at least one of:
(i) evaluating said program code to identify code segments presenting a potential dissemination of specified data to an unauthorized destination,
(ii) detecting one or more execution paths in the software application which use said specified data for an unauthorized purpose, and
(iii) analyzing the content of data flows from said software application to detect said specified data in said data flows, and
generating one or more vulnerability summaries, based, at least in part, on the results of said evaluating, said detecting, and said analyzing.

2. The method of claim 1, wherein said specified data comprises private information related to one or more individual persons.

3. The method of claim 1, wherein said evaluating is based, at least in part, on a static analysis, and wherein said static analysis is performed without execution of the application.

4. The method of claim 3, wherein said evaluating comprises at least one of:
(a) identifying code segments which permit sending said specified data to an Internet Protocol (IP) address located in a specified jurisdiction; and
(b) identifying code segments which permit sending said specified data to at least one of a permanent computer-readable storage medium, and a non-transitory computer-readable storage medium.

5. The method of claim 4, wherein at least one of (a) and (b) is performed by analyzing one or more libraries referenced by the program code.

6. The method of claim 1, wherein said evaluating is based, at least in part, on a dynamic analysis comprising:
(a) populating said application with simulated said specified data; and
(b) analyzing the content of data flows from said identified code segments, to detect said simulated specified data in said data flows.

7. The method of claim 6, wherein said populating is based, at least in part, on fuzzing techniques.

8. The method of claim 1, wherein said detecting of said execution paths comprises:
training a machine learning algorithm on a training set comprising:
(a) identified authorized execution paths within said application, and
(b) labels associated with a purpose of each said authorized execution paths,
to produce a classifier configured to classify execution paths based, at least in part, on one or more purposes, and
applying said classifier to said program code, to determine whether one or more execution paths are not associated with an allowed purpose.

9. The method of claim 8, wherein each said authorized execution path is labelled with said associated purpose, and wherein said authorized execution paths are identified using at least one of: functions traces, control flows, procedure calls, and system calls.

10. The method of claim 8, wherein said purposes are determined based, at least in part, on one or more one of: manual identification, a name associated with a said execution path, and an output associated with a said execution path.

11. The method of claim 1, wherein said data flows are received in response to one or more (i) Application Programming Interface (API) calls; and (ii) data requests delivered to said application.

12. A system comprising:
at least one hardware processor; and
a non-transitory computer-readable storage medium having stored thereon program instructions, the program instructions executable by the at least one hardware processor to:
receive a software application comprising program code,
conduct a privacy vulnerability assessment of the software application by performing at least one of:
(i) evaluating said program code to identify code segments presenting a potential dissemination of specified data to an unauthorized destination,
(ii) detecting one or more execution paths in the software application which use said specified data for an unauthorized purpose, and
(iii) analyzing the content of data flows from said software application to detect said specified data in said data flows, and
generate one or more vulnerability summaries, based, at least in part, on the results of said evaluating, said detecting, and said analyzing.

13. The system of claim 12, wherein said specified data comprises private information related to one or more individual persons.

14. The system of claim 12, wherein said evaluating is based, at least in part, on a static analysis, and wherein said static analysis is performed without execution of the application.

15. The system of claim 14, wherein said evaluating comprises at least one of:
(a) identifying code segments which permit sending said specified data to an Internet Protocol (IP) address located in a specified jurisdiction; and
(b) identifying code segments which permit sending said specified data to at least one of a permanent computer-readable storage medium, and a non-transitory computer-readable storage medium.

16. The system of claim 15, wherein at least one of (a) and (b) is performed by analyzing one or more libraries referenced by the program code.

17. The system of claim 12, wherein said evaluating is based, at least in part, on a dynamic analysis comprising:
(a) populating said application with simulated said specified data; and
(b) analyzing the content of data flows from said identified code segments, to detect said simulated specified data in said data flows.

18. The system of claim 12, wherein said detecting of said execution paths comprises:
training a machine learning algorithm on a training set comprising:
(a) identified authorized execution paths within said application, and
(b) labels associated with a purpose of each said authorized execution paths,
to produce a classifier configured to classify execution paths based, at least in part, on one or more purposes, and
applying said classifier to said program code, to determine whether one or more execution paths are not associated with an allowed purpose.

19. The system of claim 18, wherein each said authorized execution path is labelled with said associated purpose, and wherein said authorized execution paths are identified using at least one of: functions traces, control flows, procedure calls, and system calls.

20. The system of claim 18, wherein said purposes are determined based, at least in part, on one or more one of: manual identification, a name associated with a said execution path, and an output associated with a said execution path.
